(19) United States
(12) Patent Application Publication
(10) Pub. No.: US 2009/0038868 A1
(43) Pub. Date: Feb. 12, 2009

(54) Battery charger for vehicles

(76) Inventor: Charles W. Zeadker, JR., Toledo, OH (US)

Correspondence Address: Charles Zeadker, 3527 Greengate Drive, Toledo, OH, 43614, US

(21) Appl. No.: 11/584,644

(22) Filed: Oct. 20, 2006

Related U.S. Application Data
(60) Provisional application No. 60/728,892, filed on Oct. 21, 2005.

(51) Int. Cl. B60L 8/00; H02J 7/32

(52) U.S. Cl. 180/165; 320/101

(57) ABSTRACT

The invention incorporates a free air charging system where the air is compressed by the forward movement of the vehicle through a venturi-type inlet tube and associated outlet.

This turns the enclosed turbine fan using spaced apart veins or blades, also referred to as buckets. The turbine is mounted to rotate around a vertical axis and is connected to an electric generator. The electrical output of the generator is coupled to an electric storage type battery (not shown), commonly used in electric motor driven vehicles.

See drawing #1. The turbine fan mounted on a vertical axis is secured to a generator with a 4:1 gear ratio, four turns turbine, and one turn generator. This keeps the batteries charged from ten MPH to infinity. There is no need for hydrocarbon-powered engines, thus eliminating pollution.

### BACKGROUND OF THE INVENTION

1. Field of the Invention

The present invention relates to electric storage battery charging systems and, more particularly, to a system for charging electric storage batteries of electrically powered vehicles.

2. Description of the Prior Art

The prior art discloses various arrangements for air driven impellers for use in electrically powered vehicles wherein the air currents passing by or through the vehicle have been used to generate electrical energy to be retained in an electric storage battery arrangement, for example. To supplement the power provided to the battery from outside sources.

Notwithstanding the previous attempts to charge electric storage batteries, there has been a need to develop an efficient means to economically charge electric storage batteries to provide electrical energy to produce motive power for driving electrically powered vehicles.

### SUMMARY OF THE INVENTION

Surprisingly, it has been discovered that economically efficient charging of electric storage batteries for vehicles can be achieved in an electrically driven vehicle which includes an electric motor; an electric storage battery for supplying electrical energy to the electric motor; a fluid power driven turbine, a housing for the turbine having a Venturi-type fluid inlet for directing pressure fluid to drive the turbine and a fluid outlet; an electrical power generator driven by the turbine for charging the electric storage battery.

### BRIEF DESCRIPTION OF THE DRAWINGS

The invention, including the objectives and advantages, will become readily apparent to one skilled in the art from reading the following detailed description of an embodiment of the invention when considered in the light of the accompanying drawings, in which:

FIG. 1 is a top plan view of a battery charger for an electric motor driven vehicle incorporating the features of the present invention; and

FIG. 2 is a sectional view of the battery charger illustrated in FIG. 1 taken along line 2-2 thereof.

### DETAILED DESCRIPTION OF THE PREFERRED EMBODIMENT OF THE INVENTION

Referring to the drawings, there is illustrated a pressure fluid driven turbine mounted for rotation about an axis in an outer housing or enclosure having a Venturi-type fluid inlet tube and an associated fluid outlet.

The turbine, which in common parlance is often referred to as a fan, contains a plurality of circumferentially disposed spaced apart vanes or blades, sometimes referred to as buckets.

The turbine is mounted to rotate about a vertical axis and is drivingly connected to an electric generator. The electrical output of the generator is coupled to an electric storage battery (not shown) of the type commonly used in electric motor driven vehicles, for example.

Typically, the turbine is disposed within a housing having a Venturi-type air intake tube and an associated exhaust outlet. The tube is formed to be progressively smaller in cross-section from inlet to outlet thereof. The housing, in turn, may be mounted with suitable brackets to the undersurface of the vehicle hood.

It will be understood that the shaft upon which the turbine is mounted to rotate may be mechanically coupled to an associated generator through a gear train such that the gear ratio is 4:1. Accordingly, every four (4) revolutions of the turbine will result in one (1) revolution of the armature shaft of the generator.

The air intake tube of the housing is typically mounted to direct pressure air (pressure fluid) against the vanes of the turbine to cause rotation thereof. The tube has a larger diameter opening outside the housing than the diameter of the outlet end thereof. The dimensions of the inlet tube are caused to decrease from the inlet end to the outlet end.

The inlet end may be provided with a screen, for example, to prevent the admission of any undesired debris from entering the housing. Also, the screen and/or the tube could be heated to militate against freezing in inclimate weather conditions.

While it is believed that the illustrated eliptical shape of the housing is desirable, other shapes could be utilized.

In operation, the associated vehicle is placed in motion and upon reaching approximately ten (10) miles per hour, the air entering the intake tube will be constricted by the cone shaped configuration thereof causing the air flow to speed up. The accelerated air flow causes the transient fluid to gain kinetic energy as it travels through the ever constricting passageway from inlet to outlet end. The kinetic energy is supplied by a pressure gradient force. The pressure drop across the inlet tube reduces the pressure in the constriction in reaction to the acceleration. As the fluid (air) leaves the constricted outlet of the inlet tube, it is slowed by a pressure gradient force that raises the pressure toward the ambient level. The energy of the air compressed within the inlet tube impinges on the vanes or fan buckets to cause rotation of the turbine and the associated shaft. The rotation of the turbine shaft, in turn, drives the associated generator to charge the battery or batteries connected thereto.

The above described invention eliminates the need for hydrocarbon powered engines and hence reduces or eliminates pollution.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. In an electrically driven motor vehicle including an electrical motor;
an electric storage battery for supplying electrical energy to the electric motor;
a fluid power driven turbine;
a housing for the turbine having a venturi-type fluid inlet tube for directing pressure fluid to drive the turbine and a fluid outlet; and
an electric power generator driven by the turbine for charging the electric storage battery.
